(19) United States
(12) Patent Application Publication
(10) Pub. No.: US 2005/0078390 A1
(43) Pub. Date: Apr. 14, 2005

(54) Gasket for a sector of a disc filter

(76) Inventor: Jacques Gourde, Sherbrooke (CA)

Correspondence Address: OGILVY RENAULT, 1981 MCGILL COLLEGE AVENUE, SUITE 1600, MONTREAL, QC, H3A2Y3, CA

(21) Appl. No.: 10/921,121

(22) Filed: Aug. 19, 2004

(30) Foreign Application Priority Data
Aug. 22, 2003 (CA) 2,438,096

(51) Int. Cl. F16H 21/18; G02B 5/22

(52) U.S. Cl. 359/885

(57) ABSTRACT

An adhesive-free gasket for use on a sector of a disc filter. The gasket comprising a first surface and a second surface. An inner edge on the first and second surface defining at least one aperture therethrough. Two tabs on the periphery of the gasket are suitable to engage an edge of the base plate of the sector without adhesive, whereby the aperture in the gasket will coincide with the opening in the base plate.

### CROSS-REFERENCE TO RELATED APPLICATION

This application claims priority on Canadian Patent Application No. 2,438,096, filed on Aug. 22, 2003, by the present applicant.

### BACKGROUND OF THE INVENTION

1. Field of the Invention

The present invention relates to the field of disc filters used in the pulp and paper industry for processing paper machine white water.

2. Background Art

A disc filter machine used in the pulp and paper industry is comprised of a hollow central rotating shaft with approximately twenty radially symmetrical sectors connected thereon, and a vat enclosing the sectors and extending along the length of the shaft. The central rotating shaft comprises axial filtrate channels and is connected to a filtrate valve. The filtrate, which is drained via the sectors into the corresponding filtrate channels of the shaft, is vacuumed therein by way of barometric legs.

The sectors are accessible from a platform through hood doors of the disc filter machine. A sector can be described as a plane figure bounded by two radial edges and an outer arcuate edge therebetween. The radial edges converge to form a neck on the sector. Furthermore, the sector is defined by an arrangement of flow paths for directing filtrate which terminate at an exit opening at the neck of the sector and are connected to corresponding channel openings on the central rotating shaft. The neck of the sector is joined to an arcuate base plate which acts as a means of attachment for the sector onto the shaft. The curvature of the arcuate base plate is identical to the curvature of the shaft, thus enabling the base plate to be superimposed thereon. Further, the arcuate base plate of the sector is bolted onto the shaft at two opposing locations.

The working principle of the disc filter consists of the sectors rotating by way of the hollow central shaft, thus dipping into a slurry or white water bath in the vat. The slurry or white water consists of a mixture of water, fibre particles and other impurities. As the sectors rotate out of the slurry bath, a fibre residue starts to form under gravity as the sectors are dewatered. The filtrate is drained via the sectors to the corresponding filtrate channels in the central shaft and is directed to a drainage opening where it is removed. Thus, in order to seal the passageway of the filtrate from the sector to the shaft, a gasket is required therebetween.

The conventional gaskets presently utilized are manually glued onto the arcuate base plate at the end of the neck portion of the sectors to act as a sealing means for the channel connection between the shaft and the sector. In order to replace a used gasket, the sector must be manually unbolted from a distance by way of a pneumatic fastening device. Then, the gasket must be forcibly removed with scraping tools, and finally the concave contact surface of the sector must be thoroughly cleaned to ensure that no fibre particles from the slurry bath or the filtrate remain thereon. The washing is essential because the glue must be applied to a very clean surface in order for it to stick well. Once the glue has been applied and the conventional gasket has been stuck onto the cleaned surface, a curing period is required for the adhesive. During the time the sector is detached, the disc filter machine is not in operation. Thus, the production of quality filtrate from white water only commences when the sector is reattached. In the event that a number of gaskets need to be manually replaced by a single worker, the production downtime is considerable. Furthermore, the additional labour will be expensive.

Consequently, it is desirable to simplify the method in order to maximize productivity of the disc filter. machine. What is needed is a flexible gasket, propitiously suited for sectors, that is easily applied, easily removed and easily reapplied with the stability required to make an efficient gasket seal.

### SUMMARY OF INVENTION

It is therefore an aim of the present invention to provide a method of replacing a gasket on a sector of a disc, filter which substantially overcomes the disadvantages of the prior art.

It is another aim of the present invention to provide a gasket adapted to be easily installed on an arcuate base plate of a sector.

It is yet another aim of the present invention to provide a sealing gasket device substantially retaining its structural integrity to remain properly oriented on an arcuate base plate surface between a sector and a corresponding shaft, thus optimising the seal and minimizing deformation and improper orientation of the gasket during installation.

Therefore, in accordance with the present invention, there is provided an adhesive-free gasket for use on a sector of a disc filter wherein the sector includes a base plate having an opening, the gasket comprising a first surface and a second surface, an inner edge on the first surface and the second surface defining at least one aperture therethrough, at least a first mechanical attachment on a periphery of the gasket, the first mechanical attachment being adapted to engage an edge of the base plate, and at least a second mechanical attachment on the periphery of the gasket, the second mechanical attachment adapted to engage an opposite edge of the base plate, wherein the first and second mechanical attachments are suitable to engage the gasket onto the base plate of the sector without adhesive, and whereby the aperture in the gasket will coincide with the opening in the base plate.

Further in accordance with the present invention, there is provided a method for replacing a gasket on a sector of a disk filter wherein the sector includes an arcuate base plate having an opening, the method comprising the steps of providing an adhesive-free gasket having a first surface, a second surface, a first mechanical attachment and at least a second mechanical attachment on a periphery of the gasket, the first and second attachments being adapted to engage edges of the arcuate base plate of the sector, and an inner edge on the first surface and the second surface defining at least one aperture therethrough, removing a used gasket from the arcuate base plate of the sector, aligning the inner edge of the gasket with edges of the opening in the arcuate base plate of the sector by superimposing the first surface of the gasket thereon, and engaging the first mechanical attachment onto one of the edges of the arcuate base plate of the sector and engaging the second mechanical attachment onto another one of the edges of the base plate of the sector, wherein the gasket is adapted to be engaged onto the arcuate base plate without adhesive.

These and other objects and advantages of the invention will become more apparent from the following detailed description when taken in conjunction with the accompanying drawings.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a perspective view of a gasket in accordance with a preferred embodiment of the present invention;

FIG. 2 is a top plan view of the gasket according to the present invention;

FIG. 3 is a perspective view of a sector according to the prior art;

FIG. 4 is a perspective view of an arcuate base plate of a sector with a conventional gasket glued thereon, according to the prior art; and

FIG. 5 is a perspective view of a gasket in accordance with an alternative embodiment of the present invention.

### DESCRIPTION OF THE PREFERRED EMBODIMENTS

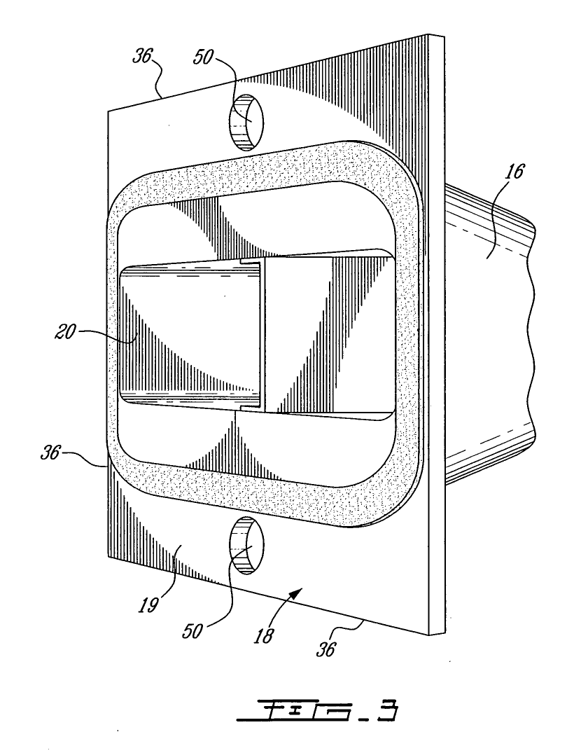

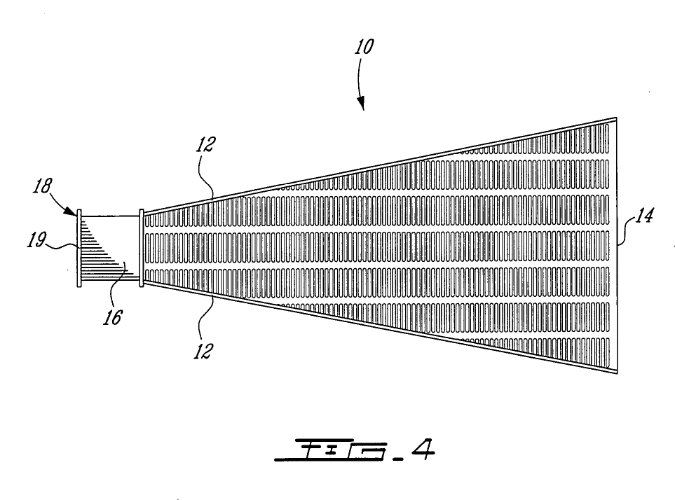

Referring now to FIG. 4 of the drawings, a sector used on a disc filter machine commonly employed today is illustrated. The sector 10 is defined by two radial edges 12 and an outer arcuate edge 14. The radial edges 12 converge to form a neck 16 on the sector 10 whereupon an arcuate base plate 18 is joined. In FIG. 3, the arcuate base plate 18 of the sector 10, which acts as a means of attachment for the sector 10 onto the central shaft, is shown with the conventional gasket presently utilized glued onto the contact surface 19 thereof. Further an exit channel aperture 20 of the sector 10 wherethrough filtrate passes is centrally located in the arcuate base plate 18.

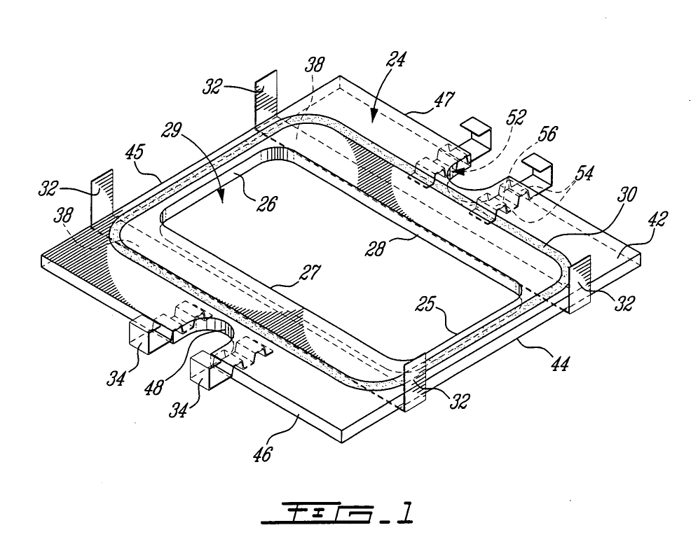

With concurrent reference to FIGS. 1, 2 and 3, a gasket in accordance with the present invention is shown at 22. The gasket 22 is generally defined by a flexible portion 24, which is preferably resilient. Referring concurrently to FIGS. 1, 2 and 4, the flexible portion 24 comprises inner edges 25, 26, 27, and 28 defining a central aperture 29 preferably of similar shape and size as the exit channel aperture 20 of a sector 10. A raised sealing portion 30 with semi-circular cross-section located on the flexible portion 24 of the gasket 22, contours the central aperture 29. The gasket 22 also comprises protruding tabs 32 and hooks 34 on its periphery adapted to be used on the edges of an arcuate base plate 36 of a sector 10. Furthermore, bands 38 are positioned parallel and adjacent to longitudinal inner edges 27 and 28 of the central aperture 29, and are provided for maintaining the structural integrity of the gasket 22.

Referring more particularly to FIG. 1, the flexible portion 24 defines a front surface 40 and a rear surface 42, both sharing exterior edges 44, 45, 46, and 57. The edges 46 and 47 comprise U-shaped edges 48, as a preferred embodiment of this invention, positioned at the half way mark. The U-shaped edges 48 ensure proper alignment of the gasket 22 on the connecting arcuate base plate 18 (FIG. 4) of the sector 10 with respect to the attachment bolts, as will be described hereinafter.

The inner edges 25, 26, 27, and 28 defining the central aperture 29 of the flexible portion 24 are parallel to the related exterior edges 44, 45, 46, and 47 of the gasket 22. The central aperture 29 acts as a trough for filtrate passing from the sector 10 (FIG. 3) to the central rotating disc shaft by way of corresponding filtrate channels.

Referring concurrently to FIGS. 1, 2 and 4, both the flexible portion 24 and the central aperture 29 may vary in size depending on the size of the arcuate base plate 18 of the sector 10 and on the size of the exit channel aperture 20 therein. Preferably, flexible portion 24 is designed to cover the entire arcuate base plate 18 surface area of the sector 10, thus ensuring the most effective seal by reducing the risk of fibre build-up which tends to form along the exterior edges of conventional sealing gaskets. This fibre build-up could develop between the contact surface 19 of the sector 10 and that of the shaft. Advantageously, the present invention is characterized by matching the surface area of the flexible portion 24 with that of the arcuate base plate 18, consequently reducing the possibility of fibre deposition therebetween.

Particularly, the flexible portion 24 is preferably made of rubber, or rubber-like material resistant to oil and fluid, such as pellethane 2363-80A. The aforementioned material will compress slightly under pressure, but offers sufficient firmness so as to become firmly seated and form a tight seal between the arcuate base plate 18 and the shaft.

Furthermore, in a preferred embodiment of the present invention, the gasket 22 comprises protruding tabs 32 as a means of attaching the gasket 22 to the arcuate base plate 18 of the sector 10, as shown concurrently in FIGS. 1, 2 and 4. Due to the fact that the thickness of the arcuate base plate 18 may vary with respect to the type of sector utilized, it is preferable that the tabs 32 be pliable and also variable in length in order to adapt to the thickness of the arcuate base plate 18. Ideally, the tabs 32 are made of a malleable metallic element such as aluminum, stainless steel or the like.

In another embodiment of the present invention best illustrated in FIG. 1, bands 38 extend parallel to the exterior edges 46 and 47 of the flexible portion 24 of the gasket 22, and perpendicularly intersect and surpass the opposing exterior edges 44 and 45 to yield the aforementioned protruding tabs 32. In this embodiment, the bands 38 are integrally joined to the tabs 32 and are also integrally moulded into the flexible portion 24 along a flat plane between the front surface 40 and the rear surface 42. The bands 38 are preferably made of a malleable metallic element. Further, the bands 38 are adjacent to inner edges 27 and 28 defining the central aperture 29, extending on both sides thereof to maintain the structural integrity of the gasket 22. It should be noted that although the bands 38 and the tabs 32 are described as integrally joined and metallic, other alternatives can also readily be used.

Referring concurrently to FIGS. 1, 2 and 4, when the reinforced sealing gasket 22 is positioned on the arcuate base plate 18 of the sector 10 around the exit channel aperture 20 therein, and attached by way of the tabs 32 onto the edges of the arcuate base plate 36, the bands 38 can be shaped into the curvature of the arcuate base plate 18 to ensure a proper seal. The bands 38 optimize the seal by having the gasket 22 pressed up against the arcuate base plate 18 before the sector 10 is reinstalled onto the cylindrical shaft. Considering that the worker installing the sector 10 on the central rotating disc shaft is positioned away from the arcuate base plate 18, the bands 38 ensure that the gasket 22 stays in position on the arcuate base plate 18. Moreover, the risk of an obstruction or any fibres getting between the arcuate base plate 18 and the gasket 22 is reduced. In addition, gasket displacement is avoided during sector reattachment because the bands 38 register the gasket 22 into place at the onset of the installation procedure. The bands 38 act as reinforcing members, minimizing deformation due to friction and compressive forces as well. Thus, the bands 38 help optimize the seal, ensuring that the gasket 22 is fully effective for sealing the sector 10 onto the shaft.

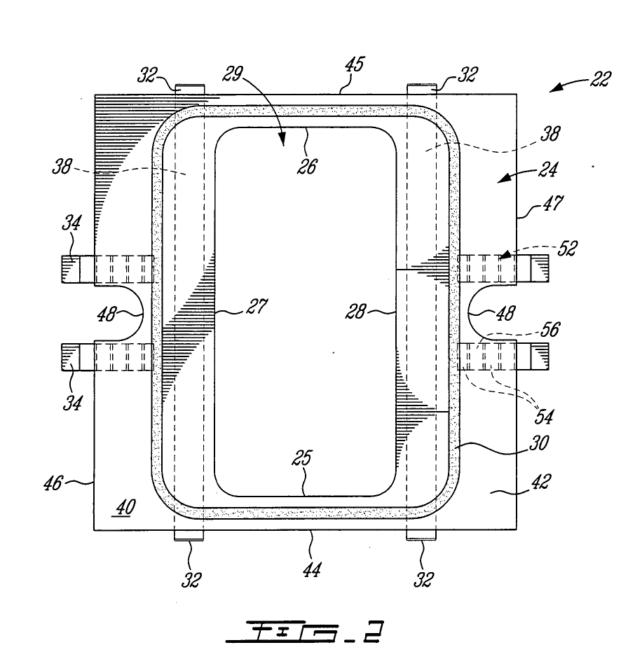

Moreover, as best seen in FIG. 2, the central aperture 29 is outlined by the raised sealing portion 30 with semi-circular cross-section located on the front surface 40 of the flexible portion 24, whose purpose is to optimize the seal between the sector 10 and the shaft. The raised sealing portion 30 is preferably resilient and accordingly shaped to surround the central aperture 29 as well as the adjacent bands 38. In FIGS. 1 and 2, the raised sealing portion 30 is illustrated in a rectangular formation with rounded corners. The raised sealing portion 30 is an elastomeric liner seal, which when compressed against the arcuate base plate 18 of the sector 10 acts as an added barrier reducing leakage between the arcuate base plate 18 and the gasket 22.

In addition, referring concurrently to FIGS. 1, 2 and 4, the gasket 22 encompasses pairs of hooks 34 protruding from the exterior edges 46 and 47 of the flexible portion 24, preferably in juxtaposition with the U-shaped edges 48 thereon. The hooks 34, symmetrically located on opposing sides of the U-shaped edges 48, are means of attachment and alignment for the gasket 22 onto the arcuate base plate 18 of the sector 10. The hooks 34 oppose the tabs 32 on the flexible portion 24, but essentially have the same function which consists of attaching the gasket 22 to the arcuate base plate 18 of the sector 10. Advantageously, the hooks 34 ensure that the U-shaped edges 48 are properly aligned with, and centered on the bolt holes 50 (FIG. 4) on the arcuate base plate 18.

In another embodiment of the present invention, the gasket 22 is provided with crenellated portions 52 which are best illustrated in FIG. 1. More distinctively, the whole crenellated portion 52 can be described as having two merlons 54 and one crenel 56, and is shown as integrally moulded within the flexible portion 24 and integrally connected to the aforementioned hooks 34.

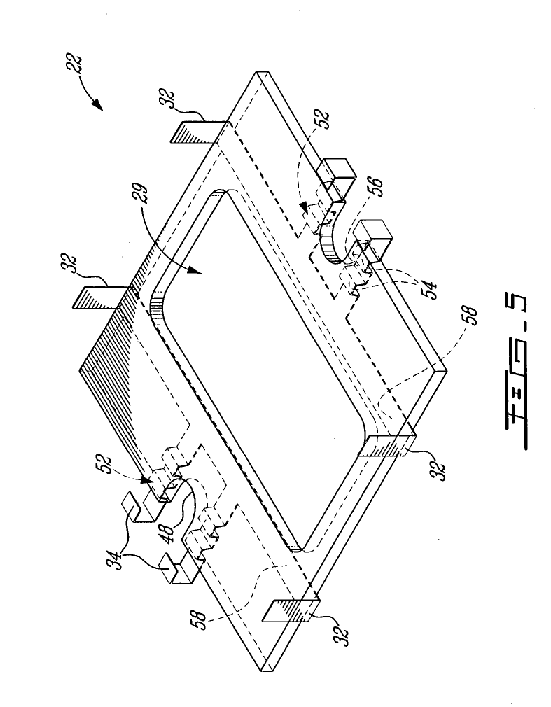

It is pointed out that an alternative configuration can also be effectively employed whereby the crenellated portions 52 are integrally connected to the aforesaid bands 38 and hooks 34. As shown in FIG. 5, the integrally moulded piece 58 is a combination of the crenellated portions 52 connected to the hooks 34 and to the bands 38 which are integrally joined to the tabs 32. Preferably, the crenellated portions 52 are at right angles with the bands 38.

Referring concurrently to FIGS. 1, 2, 4 and 5, it is preferred that the crenellated portions 52 are in juxtaposition with the U-shaped edges 48 because the crenellated portions 52 act as spacers between the arcuate base plate 18 and the cylindrical shaft. Thus, they protect against over compression of the flexible portion 24, particularly at the area surrounding the U-shaped edges 48, whereupon the exerted bolt force is strongest. Due to the fact that the sector 10 is manually reattached from a distance by way of a pneumatic fastening device, it is difficult for a worker to determine the magnitude of the torque applied onto the gasket 22 through the bolts inserted therein. It is important that the compressive force applied to the gasket 22 be of comparable magnitude on both sides to ensure a proper seal. Thus, without the spacers and in the event that one side of the flexible portion 24 is over compressed once the first of two bolts is inserted, the gasket 22 will have a tendency not to adhere as well to the arcuate base plate 18 on the opposing side whereat the bolt has not yet been installed. As a result, this occurrence creates a problem with the seal when the remaining bolt is put into place. This is largely due to the unequal distribution of compressive forces on the bolted sides of the gasket 22.

Advantageously, the crenellated portions 52 of the present invention, which are preferably made out of a metallic element, act to oppose the applied bolt force. Hence, a worker can more accurately determine the magnitude of torque needed when using a pneumatic fastening device to render an even distribution of pressure on the gasket 22.

Due to the abovementioned embodiments described hereof, the effectiveness of the seal between the arcuate base plate 18 and the cylindrical shaft is thereby optimized. The tabs 32 and hooks 34 are means of attachment and alignment of the gasket 22 onto the arcuate base plate 18. The bands 38 maintain the structural integrity of the gasket 22, while the raised sealing portion 30 ensures the integrity of the seal. Finally, the crenellated portions 52 in juxtaposition with the U-shaped edges 48 ensure that the compressive force on both sides of the gasket 22 be of comparable magnitude.

With concurrent reference to FIGS. 1, 2 and 4, the gasket 22 depicted above will now be incorporated into the method proposed in an embodiment of the present invention. With the foregoing arrangement, the gasket 22 is manually attached to the relatively clean arcuate base plate 18 of the sector 10 by way of the following methodical steps. In carrying out this method, the gasket 22 is hooked onto the peripheral edges of the arcuate base plate 36 by way of the hooks 34, while ensuring that the U-shaped edges 48 are aligned with, and centered around the bolt holes 50 on the arcuate base plate 18. Thus, the proper positioning of the gasket 22 thereby registers the inner edges 25-28 of the flexible portion 24 defining the central aperture 29 with the perimeter of the exit channel aperture 20 of the arcuate base plate 18.

Next, the tabs 32 are folded over the opposing exterior edges 44 and 45 to secure and stabilize the gasket 22 into place. Due to the fact that the arcuate base plate 18 is a concave surface, the bands 38 need to be manually form fitted by simply applying pressure so that the gasket 22 takes the shape of the surface. Once the gasket 22 is fixed onto the sector 10, the latter is reattached to the rotating cylindrical shaft and bolted thereon. The bolts further pin down the gasket 22, keeping it tightly pressed between the respective surfaces.

The foregoing description of the preferred embodiments is considered as illustrative only of the principles of the invention. Further, changes and variations which are obvious to those skilled in the art are also included in the scope of this invention because it is not desired to limit the invention to the exact construction and method shown and described.

1. An adhesive-free gasket for use on a sector of a disc filter wherein the sector includes a base plate having an opening, the gasket comprising:
a first surface and a second surface;
an inner edge on the first surface and the second surface defining at least one aperture therethrough;
at least a first mechanical attachment on a periphery of the gasket, the first mechanical attachment being adapted to engage an edge of the base plate; and
at least a second mechanical attachment on the periphery of the gasket, the second mechanical attachment adapted to engage an opposite edge of the base plate;
wherein the first and second mechanical attachments are suitable to engage the gasket onto the base plate of the sector without adhesive, and whereby the aperture in the gasket will coincide with the opening in the base plate.

2. The adhesive-free gasket as defined in claim 1 wherein the first and second mechanical attachments are bendable tabs.

3. The adhesive-free gasket according to claim 1, wherein at least one band is positioned transversely with respect to the gasket so as to maintain the structural integrity of the gasket.

4. The adhesive-free gasket according to claim 2, wherein at least one band is positioned transversely with respect to the gasket so as to maintain the structural integrity of the gasket.

5. The adhesive-free gasket according to claim 4, wherein the first tab and the second tab are integrally joined by the band.

6. The adhesive-free gasket according to claim 3, wherein the band is adjacent to one portion of the inner edge defining the aperture.

7. The adhesive-free gasket according to claim 3, wherein the band is integrally moulded therein.

8. The adhesive-free gasket according to claim 4, wherein the band and the first and second tabs are made of a malleable metallic element.

9. The adhesive-free gasket according to claim 1, wherein the inner edge defining the aperture is outlined by a raised sealing portion on the first surface.

10. The adhesive-free gasket according to claim 9, wherein the raised sealing portion is a continuous bead.

11. The adhesive-free gasket according to claim 9, wherein the raised sealing portion crosses over the band.

12. The adhesive-free gasket according to claim 1, wherein the disc filter includes a cylindrical shaft with an exterior opening communicating with a passageway and the gasket includes at least a first opening near the periphery of the gasket which corresponds with a bore in the base plate, wherethrough a bolt attaches the sector with the gasket thereon to the cylindrical shaft, whereby the opening of the base plate coincides with the exterior opening of the cylindrical shaft.

13. The adhesive-free gasket according to claim 12, wherein at least a first hook protruding from the periphery is in juxtaposition with the first opening so as to keep the opening aligned with the bore in the base plate.

14. The adhesive-free gasket according to claim 13, wherein at least a first band is positioned transversely with respect to the gasket so as to maintain the structural integrity of the gasket.

15. The adhesive-free gasket according to claim 14, wherein the first hook is integrally joined to the first band.

16. The adhesive-free gasket according to claim 15 wherein the first and second mechanical attachments are bendable tabs which are integrally joined by the first band.

17. The adhesive-free gasket according to claim 12, wherein at least a first spacer is in juxtaposition with the first opening near the periphery of the gasket, acting as a spacer between the cylindrical shaft and the base plate in order to reduce over compression of the gasket.

18. The adhesive-free gasket according to claim 13, wherein the first hook is defined by a portion of the hook having at least one crenellation integrally moulded in the gasket, which acts as a spacer between the cylindrical shaft and the base plate in order to reduce over compression of the gasket

19. The adhesive-free gasket according to claim 1, wherein the periphery and the inner edge are defined by a rectangular outline.

20. A method for replacing a gasket on a sector of a disk filter wherein the sector includes an arcuate base plate having an opening, the method comprising the steps of:
a) providing an adhesive-free gasket having a first surface, a second surface, a first mechanical attachment and at least a second mechanical attachment on a periphery of the gasket, the first and second attachments being adapted to engage edges of the arcuate base plate of the sector, and an inner edge on the first surface and the second surface defining at least one aperture therethrough;
b) removing a used gasket from the arcuate base plate of the sector;
c) aligning the inner edge of the gasket with edges of the opening in the arcuate base plate of the sector by superimposing the first surface of the gasket thereon; and
d) engaging the first mechanical attachment onto one of the edges of the arcuate base plate of the sector and engaging the second mechanical attachment onto another one of the edges of the base plate of the sector;
wherein the gasket is adapted to be engaged onto the arcuate base plate without adhesive.

21. The method of claim 20, wherein the method further comprises:
e) inserting bolts through designated holes in the base plate of the sector, the bolts passing through openings defined in the gasket near the periphery thereof to attach the sector to a cylindrical shaft of the disc filter.
